(19) United States
(12) Patent Application Publication
(10) Pub. No.: US 2004/0169053 A1
(43) Pub. Date: Sep. 2, 2004

(54) Reuseable adhesive guide

(76) Inventor: Lance Liljeqvist, Wilton, CT (US)

Correspondence Address: ST. ONGE STEWARD JOHNSTON & REENS, LLC, 986 BEDFORD STREET, STAMFORD, CT, 06905-5619, US

(21) Appl. No.: 10/686,832

(22) Filed: Oct. 16, 2003

Related U.S. Application Data
(60) Provisional application No. 60/423,676, filed on Nov. 4, 2002.

(51) Int. Cl. B67D 5/64

(52) U.S. Cl. 222/611.1; 222/391; 401/193; 401/48; 222/327

(57) ABSTRACT

A guide device attached to the end of a caulking tube to aide an individual in the application of a substance to a surface, thereby minimizing the amount of time involved to apply the substance and further minimizing unnecessary waste of the substance. The guide device being a detachable application guide with a protrusion that may be draw along a straight edge to help keep the nozzle steady during application.

### CROSS REFERENCE

This application claims priority to U.S. Provisional Patent Application No. 60/423,676 filed Nov. 4, 2002.

### FIELD OF THE INVENTION

The invention relates generally to a guide for assisting in the application of a substance, such as an adhesive or sealant, to a surface. More specifically the invention relates to an application device that is attached to the end of a source of adhesive or sealant to assist a user in applying the substance to a desired location on a surface.

### BACKGROUND OF THE INVENTION

Adhesives and sealants have been utilized for many years. The delivery means has included, for instance, a tube containing the substance and having a tapered nozzle to aid in the application of the substance, and a caulking gun into which the tube is inserted. Mechanical pressure applied to one end of the tube by the caulking gun forces the substance out of the tube and through the nozzle.

The nozzle is generally formed as an elongated conical shape where an individual may selectively cut the tapered end off at a desired location. The adhesive or sealant may then be selectively applied to a surface by the individual. One difficulty that is encountered in the application of adhesives and sealants is that it is very difficult to apply the substance in a neat and efficient manner. For instance, applying the substance to a strip of wood to form a clean bead along the edge or length of the surface may be very difficult, especially in many construction environments.

When the substance is over-applied or applied in an inconsistent manner, the individual must clean off the excess amount of the substance when, for instance, two surfaces are joined together. Alternatively, the individual may apply the substance in an erratic manner, for instance forming an bead that follows an erratic pattern rather than forming a straight line. In this case the excess substance that is not located along the centerline of the surface will also have to be cleaned off. In either case, the individual has to take extra time to clean off the extra substance. This means that the individual must spend more time on the project and a percentage of the substance is wasted.

What is desired therefore, is a device for aiding an individual in the application of a substance, such as an adhesive or sealant, to a surface, such that the substance may easily be applied in a straight line.

It is further desired to provide a device that will help an individual to minimize the over-application of a substance, such as an adhesive or sealant, to a surface.

It is still further desired to provide a device that will minimize that amount of time involved for an individual to apply a substance, such as an adhesive or sealant, to a surface.

### SUMMARY OF THE INVENTION

Accordingly, a device has been provided for assisting an individual in applying a substance, such as an adhesive or sealant, to a surface. The device may readily be utilized with standard sized caulking tubes that are designed for use with a caulking gun.

Advantageously the device may, in one embodiment, fit over the end of the nozzle of the tube. A center portion comprises deformable spines, formed in a radial pattern around a base portion such that the tube nozzle may be inserted therethrough. The deformable spines frictionally hold the device to the nozzle. Alternatively, in another embodiment, the device is provided as a threaded section that may be threaded onto for instance, an end portion of a bottle.

Also extending from the base portion is a rigid guide portion extending beyond the spines, provided to assist the individual in evenly applying the substance in a straight line. Alternatively, more than one guide portion may be provided on the device. For instance, two parallel guide portions may be utilized.

In addition, the device may also include a device nozzle section that fits over and seals the end of the tube nozzle, to further provide a guide to the substance. This device nozzle section is provided with an opening at a distal end to allow the substance to pass therethrough. The opening may include any shape desired for the application.

In one advantageous embodiment a guide device for assisting in the dispensing of a substance from a tube having a nozzle is provided comprising a protrusion radially spaced apart from the nozzle. The protrusion is located a distance (d₁) from the nozzle and extends generally parallel with the nozzle. The protrusion has a length (L₁) and extends beyond an end portion of the nozzle.

In another advantageous embodiment a guide device for assisting in the dispensing of a substance from a tube having a nozzle is provided comprising a base portion having an opening located therein, and an attachment member connected to the base portion for connecting the base portion to a tube. The guide device further comprises a protrusion attached to and extending from the base portion, the protrusion extending beyond a distal end of the nozzle.

In still another advantageous embodiment a guide device for assisting in the application of a substance to be applied to a surface is provided comprising a base portion having an opening located therein, and a plurality of spines attached to and extending from the base portion forming an attachment member. The plurality of spines are spaced apart from each other and are radially located around the opening. In addition, the plurality of spines form a restriction at a distal end of the attachment member that is smaller than the opening. The guide device further comprises a protrusion attached to and extending from the base portion, the protrusion extending beyond the distal end of the attachment member.

In yet another advantageous embodiment a device for assisting in the application of a substance to be applied to a surface is provided comprising a base portion having an opening located therein, and an attachment member connected to the base portion for connecting the base portion to a corresponding attachment member on a tube. The guide device further comprises a nozzle attached to the base portion and extending from the base portion. In addition, the nozzle forms an interior cavity and has an opening at a distal end. The guide device still further comprises a protrusion attached to and extending from the base portion, the protrusion extending beyond the distal end of the nozzle.

In still another advantageous embodiment a method of using a guide device to assist in the application of a substance, from a tube with a nozzle, to a surface is provided comprising the steps of providing a protrusion having a length (L₁) that extends beyond an end portion of the nozzle, locating the protrusion a distance (d₁) radially outward from the nozzle and positioning the protrusion such that it is generally parallel with the nozzle. The method further comprises the steps of engaging the protrusion with a straight edge the extends generally parallel with the surface, and applying a bead of substance to the surface while simultaneously drawing the protrusion along the straight edge such that the bead is applied in a straight manner.

The invention and its particular features and advantages will become more apparent from the following detailed description considered with reference to the accompanying drawings.

### BRIEF DESCRIPTION OF THE DRAWINGS

FIG. 1 is an illustration of one advantageous embodiment of the present invention.

FIG. 2 is an illustration of another advantageous embodiment of the present invention.

FIG. 3A is an illustration of the device shown in FIG. 2 in a detached position relative to a standard tube nozzle.

FIG. 3B is an illustration of the device shown in FIG. 2 in an attached position relative to a standard tube nozzle.

FIG. 4 is an illustration of the device shown in FIG. 2 attached to the tube nozzle and in use.

FIG. 5 is an illustration of still another advantageous embodiment of the present invention.

FIG. 6A is an illustration of the device shown in FIG. 5 in a detached position relative to a tube.

FIG. 6B is an illustration of the device shown in FIG. 5 in an attached position relative to a tube.

FIG. 7 is an illustration of the device shown in FIG. 5 in an attached position relative to the tube and in use.

### DETAILED DESCRIPTION OF THE DRAWINGS

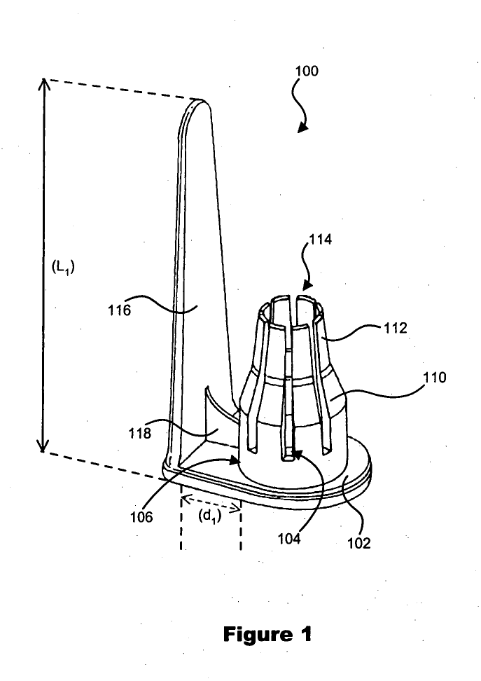

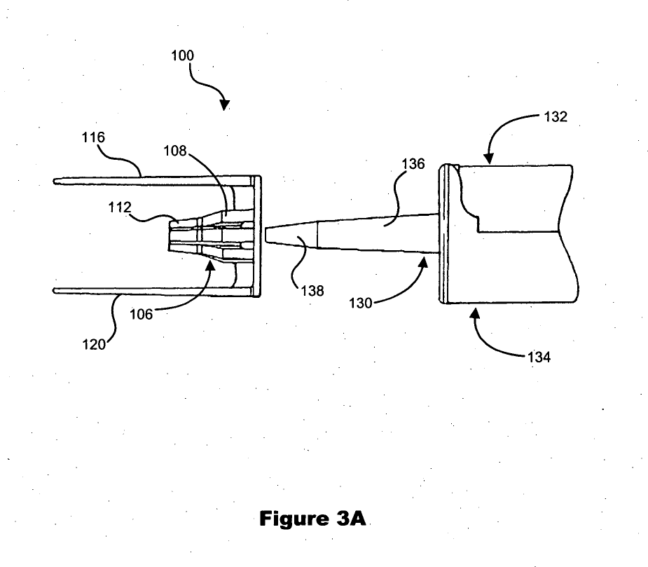

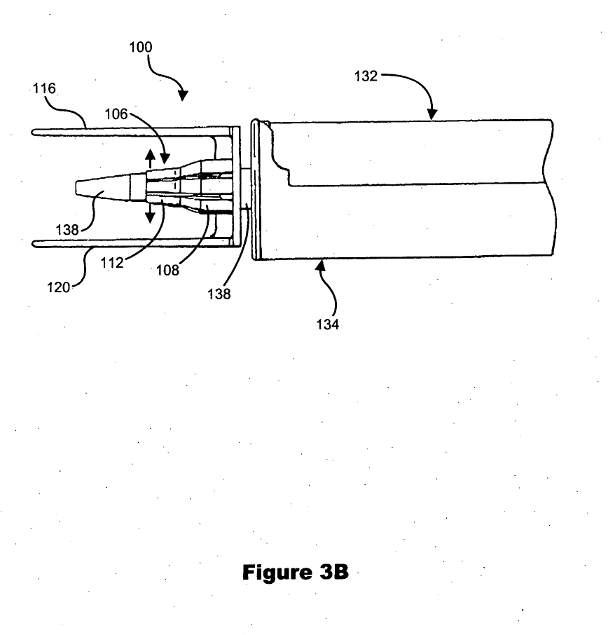

FIG. 1 is illustrates guide device 100 according to one advantageous embodiment. Guide device 100 generally comprises base portion 102, which in this embodiment is shown with a rectangular configuration although any desired shape may be utilized. Base portion 102 is provided with a hole 104 extending through the center. Hole 104 is selected to accommodate a nozzle section of a tube which will be discussed in connection with FIGS. 3A and 3B.

Surrounding hole 104 and connected to base portion 102 are spines 106. Eight separate spines are illustrated in FIG. 1, however, again it is contemplated that any number of spines may be utilized in connection with the invention. The spines are radially located around hole 104 and are generally equidistantly spaced apart from each other and together form an attachment member 106. In addition, each spine is provided with a lower spine portion 108, a tapered portion 110, and an upper spine portion 112.

Lower spine portion 108 is generally provided thicker and wider than upper spine portion 112. Tapered portion 110 is a transitional section located between lower spine portion 108 and upper spine portion 112.

Attachment member 106 forms a perimeter around hole 104 having a diameter (D₁). In addition, attachment member 106 forms an opening 114 at a distal end having a generally circular form and having a diameter (D₂). As can be seen from FIG. 1, the spines are not exactly perpendicular to base portion 102, but rather are slightly biased inward toward each other. Therefore, the diameter (D₁) of hole 104 is greater than the diameter (D₂) of opening 114.

Also connected to base portion 102 is a protrusion 116, which extends generally perpendicular from base portion 102. Protrusion 116 is located a distance (d₁) radially outward from the edge of hole 104. Protrusion 116 is also provided having a length (L₁) measured from where protrusion 116 extends from base portion 102 toward its distal end. As can be see from FIG. 1, protrusion 116 is wider where it connects to base portion 102 and thinner toward its distal end. The distal end is also provided with a rounded edge, although this is not necessary and any shape may effectively be utilized. Further, protrusion 116 is illustrated in FIG. 1 as slightly tapering from the base portion 102 to the distal end. Again, this is not required, rather it is merely advantageous to provide protrusion 102 such that it will be relatively rigid and provide firm support during use.

Also seen in FIG. 1 is web 118, which at a first edge is connected to protrusion 116, on a second edge perpendicular to the first edge is connected to base portion 102, and finally at a third edge perpendicular to the second edge and parallel to the first edge, is connected to attachment member 106. Web 118 is provided as a supporting member for protrusion 116 and will have the tendency to rigidly hold protrusion 116 perpendicular to base portion 102.

Guide device 100 may comprise any type of durable, generally rigid material such as for instance, a molded plastic, such as polypropylene or polyethylene.

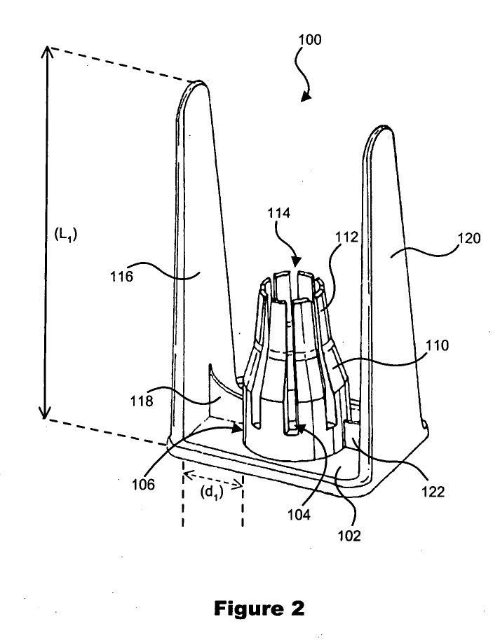

FIG. 2 is another advantageous embodiment of guide device 100. In this embodiment of guide device 100, an additional protrusion 120 is provided. Similar to protrusion 116, protrusion 120 is connected at one end to base portion 102 and is generally a mirror image of protrusion 116 on the opposite side of attachment member 106. Also provided to support protrusion 120 is web 122. Web 122 performs the same function as web 118 in connection with protrusion 116.

The remaining features of guide device 100 are equivalent to those previously described in connection with FIG. 1 and will not be described again here.

FIGS. 3A and 3B illustrate the attachment of guide device 100 to a nozzle 130. Also illustrated in FIGS. 3A and 3B is tube 132, which is located in caulk gun 134. Nozzle 130 generally comprises a main portion 136 and a tip portion 138.

As shown by the directional arrow in FIG. 3A, attachment member 106 of guide device 100 is designed to engage with nozzle 130, which passes through hole 104 provided in base portion 102. Main portion 136 of nozzle 130 is generally slightly tapered and after insertion through hole 104 and passing through opening 114, as illustrated in FIG. 3B, engages with attachment member 106. As nozzle 130 advances through the interior of attachment member 106 and engages with them, the distal end of attachment member 106 will have a tendency to spread and/or deflect radially outwardly increasing the diameter (d²) of opening 114 as illustrated by the arrows. Upper spine portions 112 are provided thinner and narrower to facilitate this deflection so as to create a frictional fitting between nozzle 130 and attachment member 106. Alternatively, lower spine portions 108 are provided thicker and stronger such that they will not deflect, but rather provide support and strength to attachment member 106. Once attached to nozzle 130, it can readily be seen that protrusion 116 extends beyond the distal end portion of nozzle 130. As discussed in connection with FIG. 1, protrusion 116 has a length (L₁) and is radially located a distance (d₁) from the edge of hole 104. While a specific measurement for distance (d₁) may be selected, it is contemplated that this measurement may vary. It should be noted that length (L₁) and distance (d₁) are related such that if distance (d₁) is increased, length (L₁) will also be increased. In this manner, a relationship exists between the length (L₁) of protrusion 116 and the distance (d₁) of protrusion 116 from the edge of hole 104.

It can be seen then from FIGS. 3A and 3B that attachment of guide device 100 to nozzle 130 is a simple and quick task. One simply slides guide device 100 over nozzle 130 until nozzle 130 engages with attachment member 106 so as to create a firm, frictional fitting between the two. In addition, guide device 100 may be rotated through 360 degrees around nozzle 130 as desired.

To remove guide device 100 from nozzle 130, one simply rotates guide device 100 while applying outward pressure to pull guide device 100 off of nozzle 130. This facilitates reuse of guide device 100 when, for instance, tube 132 is empty and must be replaced.

While guide device 100 illustrated in FIGS. 3A and 3B is shown having both protrusions 116 and 120 as described in connection with FIG. 2, the attachment method shown in FIGS. 3A and 3B is also applicable to guide device 100 illustrated in FIG. 1.

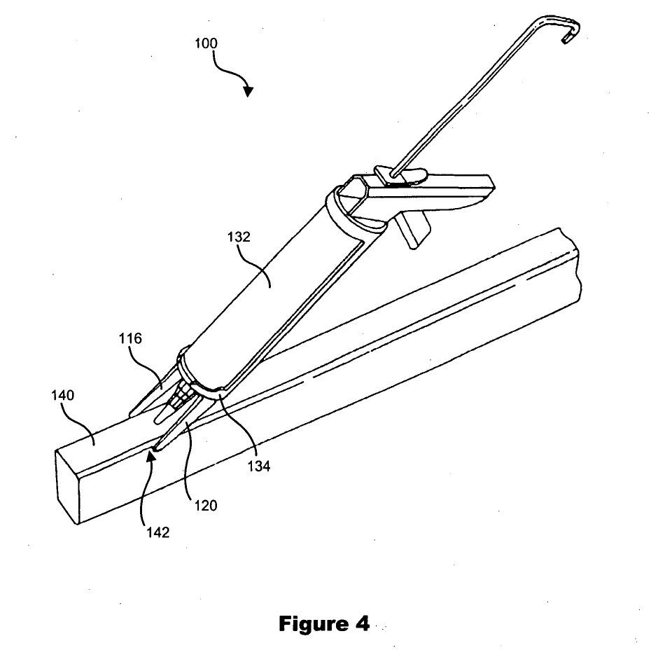

FIG.4 is an illustration of guide device 100 attached to nozzle 130 and used with tube 132 and caulking gun 134. In this illustration an individual may apply the substance, such as an adhesive or a sealant, to surface 140 in a straight and clean manner. For instance, rather than simply trying to apply a straight bead of substance to surface 140 with a steady hand, protrusions 116 and/or 120 engage with a straight edge 142 of surface 140 such that nozzle 130 does no waiver as the substance is being applied. No only does this aide the individual to make a straight bead, the individual may draw nozzle 120 across surface 140 much more rapidly thereby reducing the amount of substance that is applied to surface 140. The overall result is a quick, clean application; with a reduced possibility of over-application of the substance to surface 140, which in turn results in reduced waste of the substance.

While guide device 100 is illustrated in FIG. 4 utilizing both protrusions 116 and 120 as illustrated in FIG. 2, it is contemplated that only protrusion 116 as illustrated in FIG. 1 may be desired for certain applications. All that is required to utilize the present invention is one straight edge 142 for protrusion 116 to interact with so as to provide lateral support for nozzle 130 as the substance is being applied to surface 140.

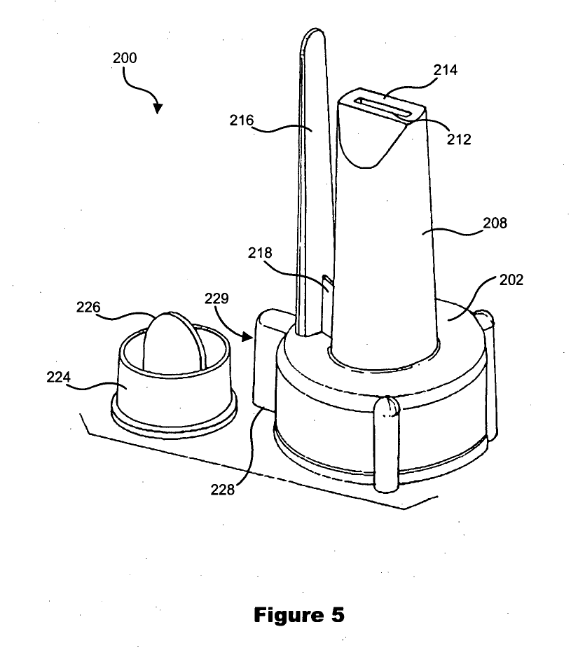

FIG. 5 illustrates another advantageous embodiment of present invention showing guide device 200. Similar to guide device 100, guide device 200 has a base portion 202, which is provided as a circular section. A hole 204 is provided in base portion 202 to facilitate the flow of a substance therethrough.

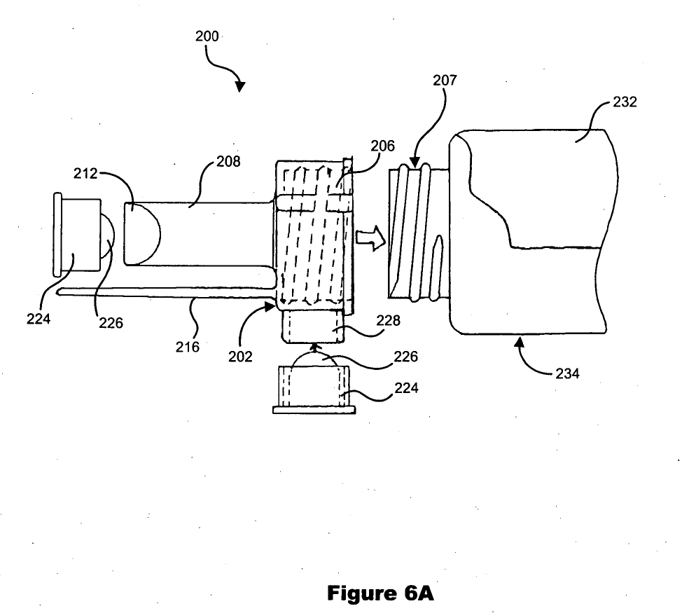

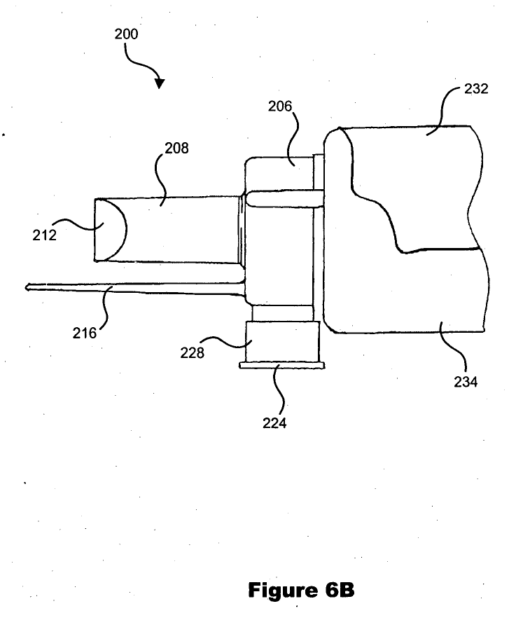

Attachment member 206 is also provided and is connected to base portion 202. In this advantageous embodiment, attachment member 206 comprises upstanding walls that generally form a cylinder, base portion 202 defining one end of the cylinder and the other end being open to receive an end portion of a tube. Attachment member 206 will be discussed in greater detail in connection with FIGS. 6A and 6B.

A nozzle 208 is further provided connected at one end to base portion 202. Nozzle 208 is provided generally as a cylinder, open as the end connected to base portion 202 and having a restriction 214 at the other end. Although nozzle 208 is generally illustrated as a cylinder, this is not necessary and any shape may be utilized as appropriate. For instance, nozzle 208 may comprise but is not limited to: a cone, conic section, frusto-conic section or a slightly tapered cylinder. As can also be seen in FIG. 5, nozzle 208 is provided with a tapered end 212, which ends in restriction 214. Again, tapered end 212 is not required but it is contemplated that it would aide in the neat application of the substance.

Restriction 214 is illustrated as an elongated slot. This again is not required, but is contemplated to be a further aide to the individual for the application of the substance.

Also provided with guide device 200 is protrusion 216, which is connected at one end to base portion 202. Protrusion 216 is generally illustrated as an elongated member extending from base portion 202 to beyond the end of nozzle 208. Protrusion 216 is provided to perform the same function as previously described for protrusion 116 in connection with FIG. 1 and will not be described again here. Web 218 is still further illustrated in FIG. 5. Web 218 is connected between, protrusion 216, base portion 202 and nozzle 208. Web 218 serves to rigidly hold protrusion 216 perpendicular to base portion 202.

Although guide device 200 is illustrated in FIG. 5 as having only one protrusion 216, it is contemplated that two protrusions, such as is illustrated in connection with FIG. 2, may be utilized with guide device 200.

Still further shown in FIG. 5 is cap 224 having tab 226. Cap 224 may be placed over the end of nozzle 208 when not in use in order to seal nozzle 208. Tab 226 may be inserted into restriction 214, which is provided as a slot. Cap 224 may simply be frictionally fit over the end of nozzle 208, with tab 226 communicating with restriction 214 to keep cap 224 firmly seated thereon. To remove, one simply applies outward pressure to remove cap 224 from nozzle 208.

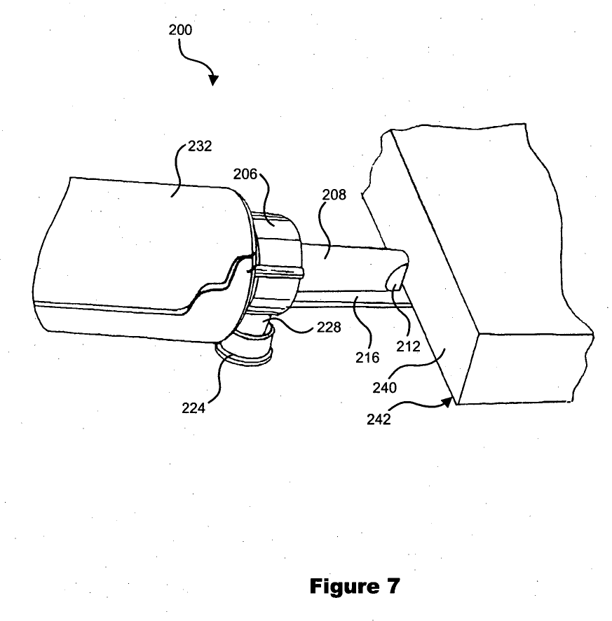

Also provided with guide device 200 is cap holder 228 having slot 229 for receiving tab 226 when guide device 200 is in use. This is further illustrated in FIG. 7.

FIGS. 6A and 6B illustrate the attachment of guide device 200 to tube attachment member 207. As can be seen in FIG. 6A for this embodiment, tube attachment member 207 is provided with threads that may engage with threads provided on the interior walls of attachment member 206. FIG. 6B illustrates guide device 200 in an engaged position with tube 232. While the attachment members are illustrated in FIG. 6A as a threaded connection, it is contemplated that many differing connections are available, such as frictional connections or interlocking members. Removal of guide device 200 is simple as one need only unscrew, or detach depending upon the connection type utilized, guide device 200 from tube 232 for reuse with a different tube.

Also illustrated in FIG. 6A is the removal of cap 224 from nozzle 208 (illustrated in dashed lines) and placement of cap 224 into cap holder 228. This will help to ensure that cap 224 does not become misplaced such that it may continue to be utilized to seal nozzle 208.

FIG. 7 is an illustration of guide device 200 in use. Here, guide device 200 is shown in an attached arrangement with tube 232 with cap 224 held in cap holder 228. Protrusion 216 is engaged with an edge 242 of surface 240 such that a bead of substance may be applied to surface 240 in an even and neat manner. In addition, nozzle 208 with restriction 214 will help to guide the substance over surface 240. Still further, tapered end 212 will also aide an individual in the even application of the substance to surface 240 as the nozzle 208 is tilted to form and acute angle with surface 240.

As stated in connection with FIG. 4, guide device 200 will allow a quick, clean application of the substance to surface 240. For instance, protrusion 216 engages with a straight edge 242 of surface 240 such that nozzle 208 does no waiver across surface 240 as the substance is being applied. This allows the individual to make a straight bead in a rapid manner, thereby reducing the amount of substance that is applied to surface 240.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A guide device for assisting in the dispensing of a substance from a tube having a nozzle, the guide device comprising:
a protrusion radially spaced apart from the nozzle, said protrusion being located a distance (d₁) from the nozzle and extending generally parallel with the nozzle, said protrusion having a length (L₁);
wherein said protrusion extends beyond an end portion of the nozzle.

2. The guide device according to claim 1 wherein distance (d₁) is related to length (L₁) such that if distance (d₁) is increased, length (L₁) is increased; and if distance (d₁) is decreased, length (L₁) is decreased.

3. The guide device according to claim 1 further comprising an attachment member for attaching the guide device to the nozzle.

4. The guide device according to claim 1 wherein the device comprises a rigid plastic.

5. The guide device according to claim 1 wherein said protrusion further comprises a base section at a first end and an end section at a second end, the base portion being rigid and the end portion being semi-rigid.

6. The guide device according to claim 5 wherein said protrusion tapers from the base section toward the end section.

7. The guide device according to claim 5 wherein the end section is rounded.

8. The guide device according to claim 1 wherein said protrusion comprises a first protrusion, the guide device further comprising a second protrusion attached to said base portion and extending substantially parallel with said first protrusion.

9. The guide device according to claim 8 wherein said second protrusion has a length (L₂), and length (L₂) is equal to length (L₁).

10. The guide device according to claim 1 wherein the nozzle has an opening at a distal end that comprises a slot, the guide device further comprising:
a cap having a tab for selectively interacting with the slot for sealing the nozzle; and
a cap holder for detachably engaging with said cap when the nozzle is being used.

11. A guide device for assisting in the dispensing of a substance from a tube having a nozzle, the guide device comprising:
a base portion having an opening located therein;
an attachment member connected to said base portion for connecting said base portion to a tube; and
a protrusion attached to and extending from said base portion, said protrusion extending beyond a distal end of the nozzle.

12. The guide device according to claim 11 wherein the device comprises a rigid plastic.

13. The guide device according to claim 11 wherein said protrusion comprises a first protrusion, the guide device further comprising a second protrusion attached to said base portion and extending substantially parallel with said first protrusion.

14. The guide device according to claim 11 wherein said attachment member comprises a threaded attachment member.

15. A guide device for assisting in the application of a substance to be applied to a surface comprising:
a base portion having an opening located therein;
a plurality of spines attached to and extending from said base portion forming an attachment member, said plurality of spines spaced apart from each other and radially located around the opening, said plurality of spines forming a restriction at a distal end of the attachment member that is smaller than the opening; and
a protrusion attached to and extending from said base portion, said protrusion extending beyond the distal end of the attachment member.

16. A device for assisting in the application of a substance to be applied to a surface comprising:
a base portion having an opening located therein;
an attachment member connected to said base portion for connecting said base portion to a corresponding attachment member on a tube;
a nozzle attached to said base portion and extending from said base portion, said nozzle forming an interior cavity and having an opening at a distal end; and
a protrusion attached to and extending from said base portion, said protrusion extending beyond the distal end of said nozzle.

17. A method of using a guide device to assist in the application of a substance, from a tube with a nozzle, to a surface, comprising the steps of:
providing a protrusion having a length (L₁) that extends beyond an end portion of the nozzle;
locating the protrusion a distance (d₁) radially outward from the nozzle and positioning the protrusion such that it is generally parallel with the nozzle;
engaging the protrusion with a straight edge the extends generally parallel with the surface; and
applying a bead of substance to the surface while simultaneously drawing the protrusion along the straight edge such that the bead is applied in a straight manner.
